(19) United States
(12) Patent Application Publication
(10) Pub. No.: US 2009/0282296 A1
(43) Pub. Date: Nov. 12, 2009

(54) MULTIVARIATE FAULT DETECTION IMPROVEMENT FOR ELECTRONIC DEVICE MANUFACTURING

(75) Inventor: Y. SEAN LIN, Irvine, CA (US)

Correspondence Address: APPLIED MATERIALS/BSTZ;BLAKELY SOKOLOFF TAYLOR & ZAFMAN LLP, 1279 OAKMEAD PARKWAY, SUNNYVALE, CA, 94085-4040, US

(73) Assignee: Applied Materials, Inc., Santa Clara, CA (US)

(21) Appl. No.: 12/368,164

(22) Filed: Feb. 9, 2009

Related U.S. Application Data
(60) Provisional application No. 61/127,041, filed on May 8, 2008.

(51) Int. Cl. G06F 11/07

(52) U.S. Cl. 714/46; 714/E11.029

(57) ABSTRACT

An importance factor generator system for providing an overall importance factor to be used in normalizing variables for multivariate modeling. An importance factor generator system assigns a sensor importance factor (IF) to a sensor, where the sensor IF indicates the importance of the sensor relative to other sensors. The importance factor generator system assigns a recipe step IF to a recipe step, where the recipe step IF indicates the importance of the recipe step relative to other recipe steps. The importance factor generator system can calculate an overall IF using the sensor IF and recipe step IF and provide the overall IF to be used for normalizing variables for multivariate modeling results. The importance factor generator system can display the overall IF in a graphical user interface (GUI).

### RELATED APPLICATION

The present application claims priority to U.S. Provisional Application Ser. No. 61/127,041, filed May 8, 2008, which is incorporated herein in its entirety.

### TECHNICAL FIELD

Embodiments of the present invention relate to fault diagnosis, and more specifically to multivariate fault detection improvement for electronic device manufacturing.

### BACKGROUND OF THE INVENTION

Many industries employ sophisticated manufacturing equipment that includes multiple sensors and controls, each of which can be carefully monitored during processing to detect and/or diagnose faults (e.g., a malfunction or maladjustment of manufacturing equipment). Faults can produce defects in the devices being manufactured. Accordingly, industries implement statistical process monitoring to detect and/or diagnose faults before they produce such defects. During statistical process monitoring, a fault can be detected when one or more of the statistics of recent process data deviate from a statistical model by an amount great enough to cause a model metric to exceed a respective confidence threshold. A model metric is a scalar number whose value represents a magnitude of deviation between the statistical characteristics of actual process data and the statistical characteristics predicted by the model. A statistical model (e.g., a multivariate fault detection (MFD) model) is able to analyze hundreds of variables. In calculating a model metric, variables are normalized in order to compare the different types of variables. A common method used for normalizing variables is by mean-centering each variable and then scaling each variable with its standard deviation, which can be expressed in the following exemplary equation:

$$Z = \frac{( x - \overline{x} )}{{σ}_{x}} \qquad Eq . 1$$

where z is the scaled value of variable x, x̅ is the mean value of x, and σₓ is the standard deviation for x. Equation 1 converts a variable x to z making an assumption that the relative importance of the variable is directly related to the standard deviation. However, in semiconductor manufacturing chambers the process window may be so narrow that the standard deviation becomes dominated by the sensor resolution (the smallest change the sensor can detect in the quantity that it is measuring). As a result, the above mention method is sometimes incorrect for summary statistics of semiconductor manufacturing chambers. However, there is a solution described in U.S. Patent Application titled “Ranged Fault Signatures for Fault Diagnosis,” where Equation 1 is changed to the following exemplary equation:

$$z = \frac{( x - \overline{x} )}{maximum ( {σ}_{x} , {σ}_{l} )} \qquad Eq . 2$$

where z is the scaled value of variable x, x̅ is the mean value of x, σₓ is the standard deviation for x, and σₜ is a threshold value determined by sensor resolution. A common issue with regard to the methods of both Equation 1 and Equation 2 is that both methods essentially make an assumption that the relative importance of a variable is directly related to the standard deviation of the variable. Although this assumption allows for the comparison of different variables together, it is sometimes incorrect.

### BRIEF DESCRIPTION OF THE DRAWINGS

The present invention is illustrated by way of example, and not by way of limitation, in the figures of the accompanying drawings and in which:

FIG. 1 illustrates an statistical process monitoring system in accordance with one embodiment of the invention;

FIG. 2 illustrates a flow diagram of one embodiment for a method for generating an importance factor for normalizing variables;

FIG. 3A illustrates an exemplary graphical user interface (GUI) for managing sensor specific importance factors, in accordance with one embodiment;

FIG. 3B illustrates an exemplary GUI for managing recipe step specific importance factors, in accordance with one embodiment;

FIGS. 4A and 4B illustrate exemplary GUIs for managing statistic importance factors in a step view, in accordance with one embodiment;

FIG. 4C illustrates an exemplary GUI for managing statistic importance factors in a sensor view, in accordance with one embodiment;

FIG. 5 illustrates a trend plot model of a multivariate model metric for multiple samples in accordance to an embodiment of the invention; and

FIG. 6 illustrates an exemplary computer system to perform methodologies in accordance with embodiments of the present invention.

### DETAILED DESCRIPTION

Embodiments of the invention are directed to a method and system for providing an overall importance factor to be used in normalizing variables for multivariate modeling. An importance factor generator system assigns a sensor importance factor (IF) to a sensor, where the sensor IF indicates the importance of the sensor relative to other sensors. The importance factor generator system assigns a recipe step IF to a recipe step, where the recipe step IF indicates the importance of the recipe step relative to other recipe steps. The importance factor generator system can calculate an overall IF using the sensor IF and recipe step IF and provide the overall IF to be used for normalizing variables for multivariate modeling results. The importance factor generator system can display the overall IF in a graphical user interface (GUI). The GUI can receive a user input modifying the sensor IF and recipe step IF and the system can provide another overall IF based on the user input until the overall IF is deemed acceptable by a system user. This method and system makes an importance factor available for each variable (e.g., sensor, recipe step, statistic) such that the variable importance is no longer tied to a standard deviation and a fault detection system is more sensitive to faults without being directly related to the standard deviation of the variable.

Equation 2 described above can be changed to the following exemplary equation which uses an overall importance factor for normalizing variables for multivariate models:

$$z = {IF}^{*} \frac{( x - \overline{x} )}{maximum ( {σ}_{x} , {σ}_{l} )} \qquad Eq . 3$$

where z is the scaled value of variable x, x̅ is the mean value or variable x, σₓ is the standard deviation for variable x, σₜ is a threshold value determined by sensor resolution, and IF is an overall importance factor.

In the following description, numerous details are set forth. It will be apparent, however, to one skilled in the art, that the present invention can be practiced without these specific details. In some instances, well-known structures and devices are shown in block diagram form, rather than in detail, in order to avoid obscuring the present invention.

Some portions of the detailed description which follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “assigning”, “providing”, “calculating”, “determining”, “displaying,” “replacing,” “receiving” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present invention also relates to an apparatus for performing the operations herein. This apparatus can be specially constructed for the required purposes, or it can comprise a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems can be used with programs in accordance with the teachings herein, or it may prove convenient to construct a more specialized apparatus to perform the method steps. The structure for a variety of these systems will appear from the description below. In addition, the present invention is not described with reference to any particular programming language. It will be appreciated that a variety of programming languages can be used to implement the teachings of the invention as described herein.

A machine-readable storage medium can include any mechanism for storing information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only memory (EPROM), Electrically Erasable Programmable Read-Only Memory (EEPROM), magnetic or optical cards, flash memory, or the like.

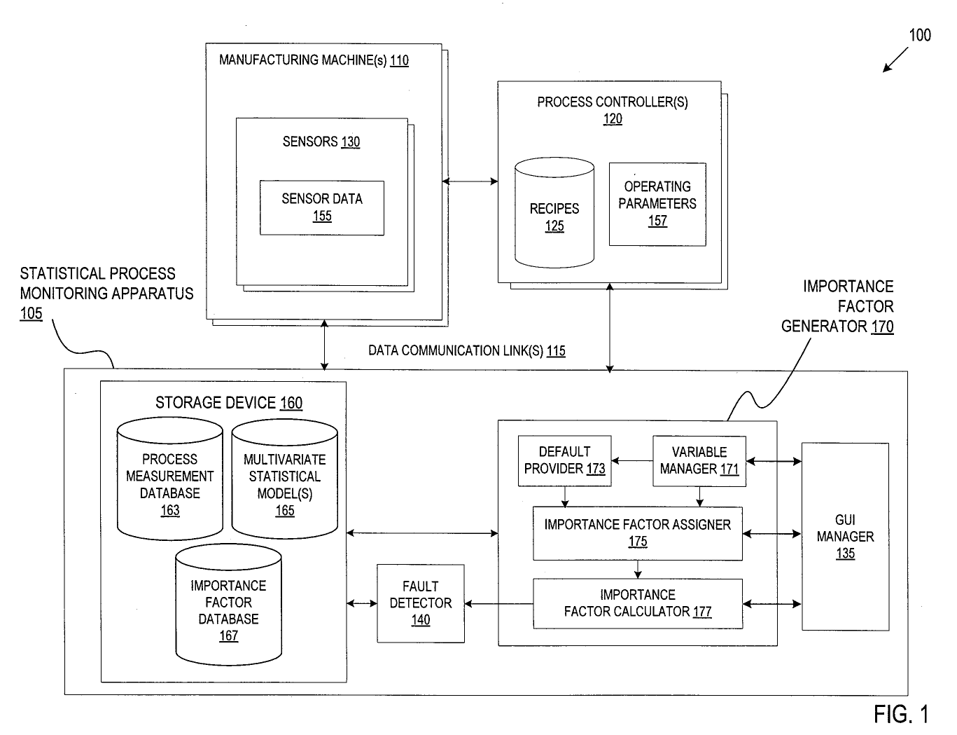

FIG. 1 illustrates one embodiment of statistical process monitoring system 100 for providing an overall importance factor to normalize variables for multivariate modeling. In one embodiment, the statistical process monitoring system 100 is used in the manufacturing of electronic devices (e.g., semiconductors). Manufacturing such devices generally includes dozens of manufacturing steps involving different types of manufacturing processes. Alternatively, the statistical process monitoring system 100 can be used to monitor the manufacture of other products (e.g., automobiles), which may also include many different processing steps by various manufacturing machines.

The statistical process monitoring system 100 can include a statistical process monitoring apparatus 105 coupled with one or more manufacturing machines 110 and one or more process controllers 120 by data communication links 115. The statistical process monitoring system 100 can include all manufacturing machines 110 in a factory (e.g., a fabrication facility) or only some manufacturing machines 110 in the factory. Each of the manufacturing machines 110 can be a machine for the manufacture of electronic devices (e.g., etchers, chemical vapor deposition furnaces, etc.) or of a type for manufacturing other products. Each manufacturing machine 110 can include multiple sensors 130 for monitoring processes run on the manufacturing machine 110. Examples of types of sensors include temperature sensors, pressure sensors, or any other sensors that monitor physical conditions of a manufacturing process or physical properties of a work piece manufactured by the manufacturing machines 110. Process controllers 120 control operating parameters 157 of manufacturing machines 110 (e.g., chamber temperature, vacuum pumps, etc.). Process controllers 120 can store one or more process recipes 125 which can define the operating parameters 157 of a manufacturing machine 110 at each step of a process.

Process data characterizes a manufacturing process that is performed on a manufacturing machine 110. Process data can collectively refer to various physical conditions and properties measured by the sensors 130 (e.g., sensor data 155), and by various operating parameters 157 (e.g., chamber temperature, vacuum pumps, gas injection systems). Sensor data 155 and operating parameters 157 can be distinct process variables of the process data. Examples of process variables representing sensor data 155 include chamber pressure and susceptor temperature. Examples of process variables representing operating parameters 157 include flow rate settings (e.g., of chemical reagents) and throttle valve settings (e.g., for a chamber exhaust vacuum pump). Process data can be gathered at successive points in time by monitoring the sensors 130, manufacturing machines 110, and process controllers 120 during processing.

Statistical process monitoring apparatus 105 can be a single server that analyzes incoming process data (e.g., sensor data 155, operating parameters 157) from the manufacturing machines 110, sensors 130 and process controllers 120. Alternatively, the statistical process monitoring apparatus 105 can include multiple servers and/or computers. Statistical process monitoring apparatus 105 can include fault detector 140, GUI manager 135, storage device 160 and importance factor generator 170 to monitor processes run on manufacturing machines 110 to detect and/or diagnose faults. Fault detector 140, GUI manager 135, and importance factor generator 170 can be hosted on a single computer system, on separate computer systems, or a combination thereof. Statistical process monitoring apparatus 105 can be included in one or more process controllers 120 or can be a distinct and/or separate apparatus.

Storage device 160 can include process measurement database 163, one or more multivariate statistical models 165, and importance factor database 167. Storage device 160 can be a single storage device of a computer or server of statistical process monitoring apparatus 105, or can be external to statistical process monitoring apparatus 105. Storage device 160 may represent multiple storage devices. Process measurement database 163 can store process data. Process data can be collected during a training period to generate statistics (e.g., mean, variance, covariance matrix, etc.). These statistics are used collectively to generate one or more multivariate statistical models 165, generally for a specific process that runs on a specific machine. Each multivariate statistical model 165 can include one or more model metrics (scalar values that characterize an amount of deviation between a set of process data and a model). Model metrics can include Squared Prediction Error (commonly referred to as SPE, Qᵣₑₛ, or Q) and Hotellings T². Each of these metrics corresponds to a different method of estimating the probability that actual process data being monitored has the same statistics as training data that may have been used to build the model. The aforesaid statistics and metrics can be calculated in accordance with conventional statistics algorithms.

Fault detector 140 can detect faults by calculating statistics of the process data for the processes being monitored, and comparing the calculated statistics with corresponding statistics of appropriate multivariate statistical models 165. Fault detector 140 can receive process data 150 directly from the manufacturing machines 110, sensors 130 and/or process controllers 120, from the process measurement database 163, or from both sources. The statistics can be compared for one model metric (e.g., T², SPE, CMI), or for multiple model metrics. If one or more of the model metrics exceed a predetermined threshold (referred to as a confidence limit or control limit), a fault may be detected. In calculating a model metric, each of the variables is normalized.

Importance factor generator 170 can provide an overall importance factor for use in normalizing the variables (e.g., sensor data 155, operating parameters 157). The importance factor generator 170 (IF generator) can include a variable manager 171, default provider 173, importance factor assigner 175, and importance factor calculator 177 to generate an overall importance factor. An overall importance factor can be calculated using importance factors assigned to individual variables. For example, exemplary Equation 4 calculates an overall importance factor, IF, using an importance factor for an individual sensor and an importance factor for an individual recipe step:

IF=IF.sensor*IF.step Eq. 4

where IF.sensor is the assigned importance factor for a sensor to indicate a relative importance of the particular sensor among sensors and IF.step is the assigned importance factor for a recipe step to indicate to indicate a relative importance among recipe steps.

In another example, exemplary Equation 5 calculates an overall IF using an importance factor for an individual sensor, an importance factor for an individual recipe step, and an importance factor for an individual statistic associated with the sensor and recipe step:

IF=IF.sensor*IF.step*IF.statistic Eq. 5

where IF.statistic is the assigned importance factor value for a statistic (e.g., average, standard, minimum, maximum, median, area, slope, count range z, and range y, etc.).

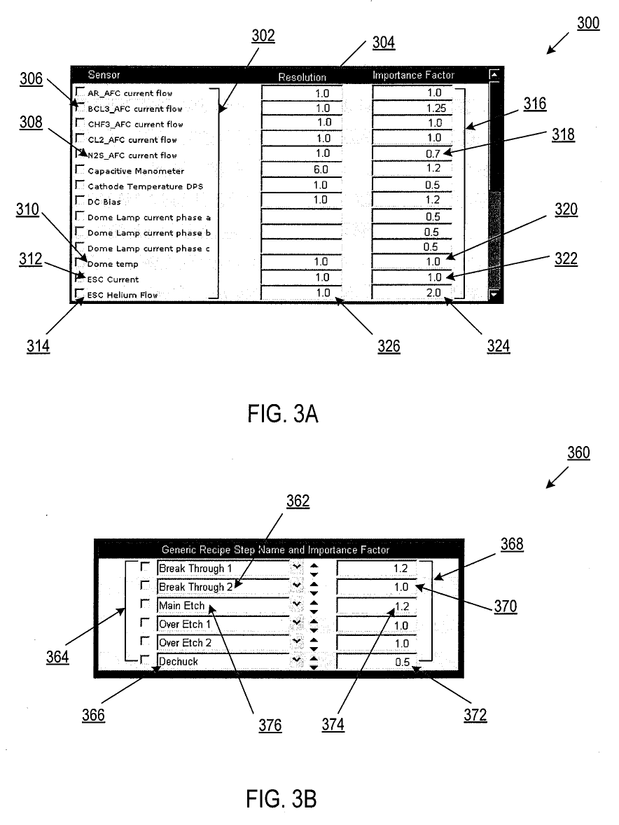

Variable manager 171 can manage the importance factor assigned to an individual variable (e.g., sensor, recipe step, and statistic). As discussed above, a MFD model can analyze thousands of variables. However, in actuality, a subset of the variables may be monitored and analyzed instead. Referring to the previous example of an MFD model having 40 sensors, 40 recipe steps, and more than 10 summary statistics, variable manager 171 can determine the subset of these variables to be managed. In one embodiment, variable manager 171 determines the subset of selected variables by receiving a user input via a GUI. GUI manager 135 can generate a GUI to receive the user input. FIG. 3A, discussed in greater detail below, illustrates an exemplary GUI for receiving a user input for selecting variables, in accordance with one embodiment of the invention.

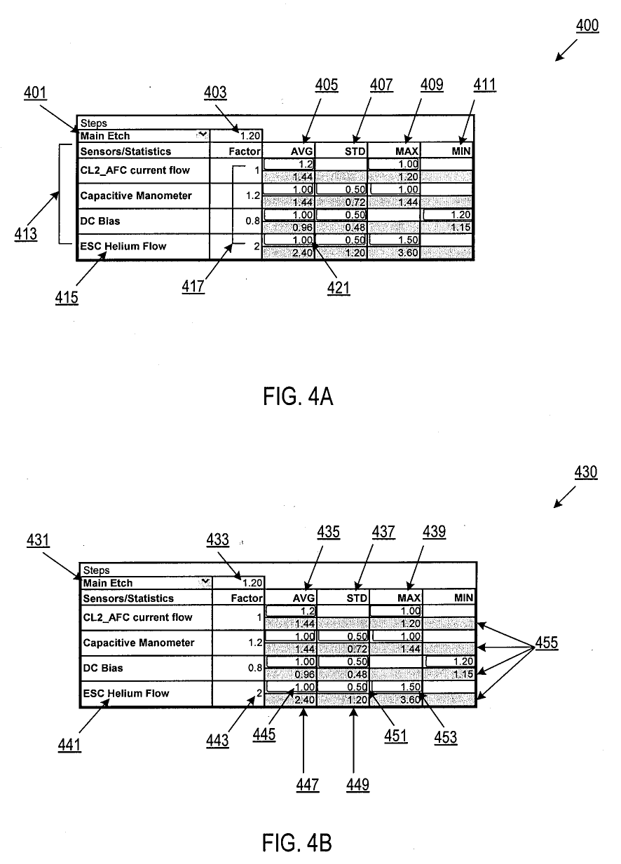

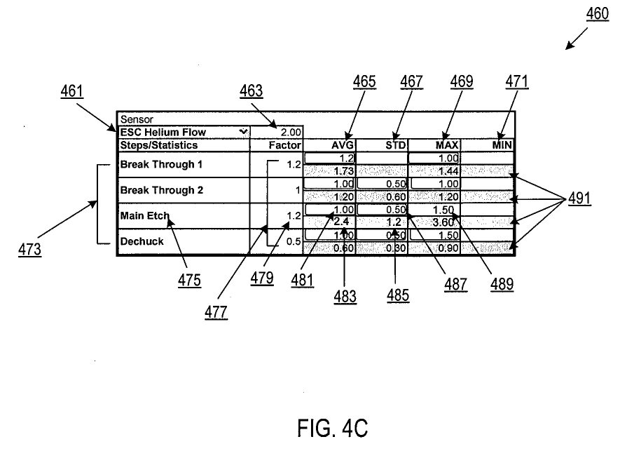

Default provider 173 can provide a default importance factor value for each of the variables to be managed, as determined by, for example, variable manager 171. An exemplary default importance factor value provided for each variable can be a value of 1.0. Importance factor assigner 175 (IF assigner) can obtain a default importance factor value from default provider 415 and assign an importance factor to each of the variables to be managed as determined by variable manager 171. IF assigner 175 can also obtain importance factor values as a user input via a GUI and replace the default values obtained from default provider 173 with the user input values. GUI manager 135 can generate a GUI and receive a user input to provide to IF assigner 175. For example, where a default importance factor value of 1.0 is assigned to a specific sensor, such as, ESC Helium Flow, IF assigner 175 can receive a user defined importance factor value of 2.0 to replace the default value assigned to sensor ESC Helium Flow. In this example, the importance factor for the ESC Helium Flow sensor is increased from 1.0 to the user defined importance factor of 2.0. The increase can indicate a greater degree of importance assigned to sensor ESC Helium Flow relative to other sensors. In another example, where a default importance factor of 1.0 is assigned to sensor Cathode Temperature DPS, IF assigner 175 can receive a user defined importance factor value of 0.5 to replace the default value previously assigned to sensor Cathode Temperature DPS. In this example, the user defined importance factor of 0.5 can indicate a lesser degree of importance assigned to sensor Cathode Temperature DPS relative to other sensors. FIGS. 3A-3B and 4A-4C, discussed in greater detail below, illustrate exemplary GUIs for receiving a user defined importance factor value, in accordance with one embodiment of the invention.

Importance factor calculator 177 can calculate an overall importance factor using the importance factor assigned to each of the selected variables. The overall importance factor can be stored in IF database 167. IF database 167 can also store a pre-defined default importance factor value for each variable and a user defined importance factor for each variable. IF database 167 can also store information pertaining to which variables are selected to be managed as determined by variable manager 171. In one embodiment, IF database 167 can reside on storage device 160.

Fault detector 140 can obtain the overall importance factor from importance factor calculator 177 to normalize the variables of a MFD model. For example, fault detector 140 can use the previously described exemplary Equation 3:

$$z = IF * , \frac{( x - \overline{x} )}{maximum ( {σ}_{x} , {σ}_{l )}} \qquad Eq . 3$$

where IF is the overall importance factor received from IF calculator 177.

GUI manager 135 can also obtain the overall importance factor from IF calculator 177 to display in a GUI. GUI manager 135 can generate user interfaces for receiving and displaying importance factors. FIGS. 3A-3B and 4A-4C, described in greater detail further below, illustrate exemplary GUIs to receive and display importance factors, in accordance with one embodiment of the invention.

Data communication links 115 can include conventional communication links, and can be wired or wireless. Data can be transmitted between the manufacturing machines 110, the process controllers 120 and the statistical process monitoring apparatus 105 in a raw or processed format. In one embodiment, a semiconductor equipment communications standards (SECS) interface is used. In other embodiments, a generic model for communications and control of manufacturing equipment (GEM) interface, a SECS/GEM interface, a high speed SECS message services (HSMS) interface, etc, can be used.

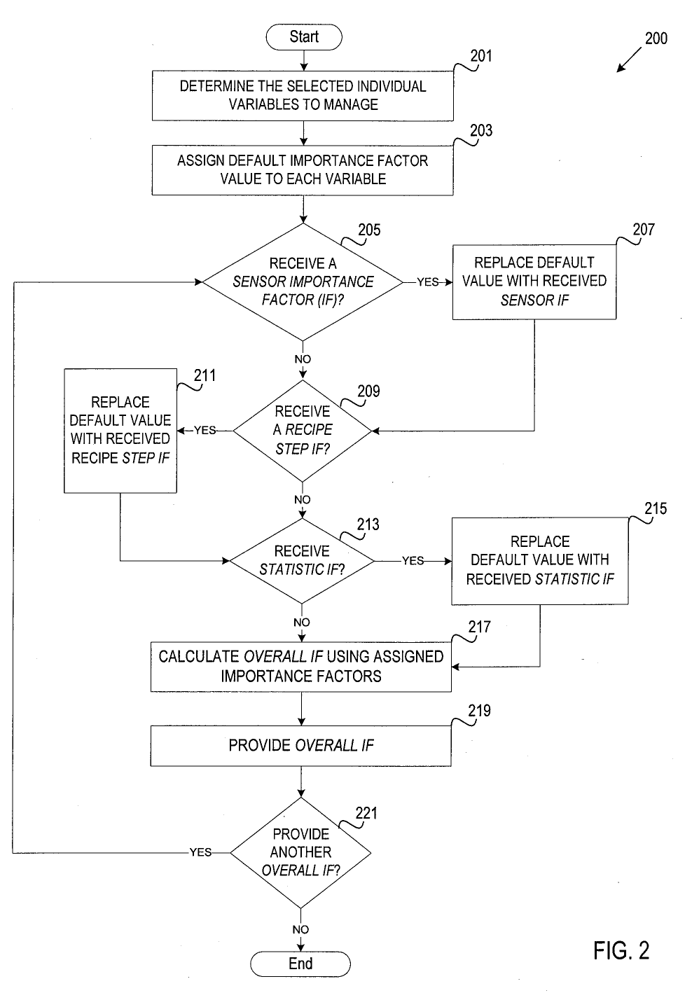

FIG. 2 illustrates one embodiment of a method 200 for generating an overall importance factor for improving multivariate fault detection. Method 200 can be performed by processing logic that can comprise hardware (e.g., circuitry, dedicated logic, programmable logic, microcode, etc.), software (e.g., instructions run on a processing device), or a combination thereof. In one embodiment, method 200 is performed by the statistical process monitoring apparatus 105 of FIG. 1.

As described above, a typical MFD model can possibly include thousands of variables, which are difficult to manage. Typically, however, a subset of the variables is managed instead. In one embodiment, at block 201, processing logic determines which of the variables to manage. Processing logic can receive a user input via a GUI to identify the selected variables to manage.

At block 203, a pre-defined default importance factor value is assigned to each variable to be managed. An exemplary pre-defined value of 1.0 can be assigned as a default importance factor for each variable (e.g., sensor, recipe step, and statistic variable). However, as described in greater detail below, a value different (e.g., greater than or less than) from the default value can be received as the assigned importance factor for a specific variable to be used instead of the default value provided.

At block 205, processing logic determines whether a sensor importance factor value (e.g., IF.sensor) is received for a specific sensor to be used instead of the default sensor importance factor provided. If a sensor importance factor value is not received, the default value continues to be the assigned importance factor value for the specific sensor, and processing logic continues to block 209. If a sensor importance factor value is received (block 205), processing logic replaces the default value with the received value as the assigned importance factor for the specific sensor at block 207. The sensor importance factor value can be received as a user input via a GUI. FIG. 3A illustrates an exemplary GUI 300 for managing sensor specific importance factors. GUI 300 can include a list of sensors (302) and corresponding selection boxes (306) to receive a user input indicating the selection of the individual variables to be managed. In other embodiments, a GUI can use other GUI elements (e.g., radial buttons, drop down list, etc.) to receive a user input selecting variables to be managed. For each sensor listed (302), GUI 300 can include a corresponding importance factor interface (316) for receiving and displaying an assigned importance factor value. GUI 300 illustrates that a sensor importance factor was not received for sensor ESC Current (312) and that the value 1.0 (322) continues to be the assigned importance factor for sensor ESC Current (312). In another example, sensor Dome temp (310) continues to have the default value 1.0 (320) as the assigned importance factor.

In another example, the value 0.7 (318) replaced the default value of 1.0 (not shown) as the assigned importance factor for sensor N2S_AFC current flow (308). The replacement of the default value of 1.0 with the decreased value of 0.7 (318) can indicate that a lesser degree of importance is placed on sensor N2S_AFC current flow (308) relative to other sensors. In another example, the value 2.0 (324) replaced the default value of 1.0 (not shown) as the assigned importance factor for sensor ESC Helium Flow (314). The replacement of the default value of 1.0 with the increased value of 2.0 (324) can indicate that a greater degree of importance is placed on sensor ESC Helium Flow (314) relative to other sensors. In one embodiment, GUI 300 includes an interface to receive a sensor resolution (304) value, the smallest change the sensor can detect in the quantity that it is measuring, for a particular sensor. For example, a resolution value of 1.0 (326) is received and assigned to sensor ESC Helium Flow (314).

Returning to FIG. 2, at block 209, processing logic determines whether a recipe step importance factor value (e.g., IF.step) is received for a specific recipe step to be used instead of the default recipe step importance factor provided. If a recipe step importance factor value is not received, the default value continues to be the assigned importance factor value for the specific recipe step and processing logic continues to block 213. FIG. 3B illustrates an exemplary GUI 360 for receiving and assigning recipe step importance factors, in accordance with one embodiment of the invention. GUI 360 can include a list of recipe steps (364) and an interface (368) to receive an importance factor corresponding to a recipe step. GUI 360 illustrates that the default value 1.0 (370) continues to be the assigned importance factor for recipe step Break Through 2 (362).

Returning to FIG. 2, if a recipe step importance factor value is received (block 213), processing logic replaces the default value previously assigned with the received value as the assigned importance factor for the specific recipe step at block 211. In one embodiment, processing logic receives a recipe step importance factor value as a user input via a GUI. GUI 360 illustrates the replacement of default values with decreased or increased importance factor values. For example, the decreased value of 0.5 (372) assigned to recipe step Dechuck (366) can indicate a lesser degree of importance is placed on recipe step Dechuck (366) relative to other recipe steps. The replacement of the default value of 1.0 (not shown) with an increased value of 1.2 (374) assigned to recipe step Main Etch (376) can indicate a greater importance is placed on recipe step Main Etch (376) relative to other recipe steps.

Returning to FIG. 2, at block 213, processing logic determines whether a statistic importance factor value (e.g., IF.statistic) is received for a statistic to be used instead of the default statistic importance factor provided. Each statistic importance factor corresponds to a particular recipe step-sensor pair (or sensor-recipe step pair). For example, recipe step Main Etch can be paired with sensor ESC Helium Flow. The Main Etch-ESC Helium Flow pair has corresponding statistics (e.g., average, standard deviation, maximum, minimum, etc.). Each statistic for the Main Etch-ESC Helium Flow pair has an assigned statistic importance factor value indicating a relative importance among statistics.

In one embodiment, a statistic importance factor may not be used in calculating an overall importance factor, as illustrated in exemplary Equation 4:

IF=IF.sensor*IF.step Eq. 4

In such a case, processing logic proceeds to block 217 where the overall importance factor can be calculated using the importance factor values assigned to a sensor and a recipe step.

In another embodiment, a default importance factor value can be assigned as the importance factor for a statistic. For example, an exemplary value of 1.0 may be assigned as the importance factor value for each statistic for each recipe step-sensor pairing. If a statistic importance factor value is not received (block 213), the default value continues to be the assigned importance factor value for the statistic corresponding to the particular recipe step-sensor pair and processing logic continues to block 217. FIGS. 4A and 4B illustrate exemplary GUIs to receive and display statistic specific importance factors in a recipe step view.

For example, GUI 400 manages the importance factors associated with recipe step Main Etch (401). The assigned importance factor value for recipe step Main Etch (401) is 1.2 (403). In one embodiment, the assigned value for recipe step Main Etch (401) is presented as a result from an assignment made using, for example, GUI 360 of FIG. 3B. GUI 400 can include a list of sensors (413) corresponding to the recipe step, in this example, Main Etch (401). Main Etch (401) recipe step includes the sensors (413) for current flow, capacitance, DC bias, and helium flow. A corresponding importance factor (417) can be assigned to each sensor listed. In one embodiment, the importance factors (417) displayed for each sensor are the sensor importance factors assigned using, for example, GUI 360 of FIG. 3B. GUI 400 can display an importance factor assigned to a statistic (e.g., average (AVG 405), standard deviation (STD 407), maximum (MAX 409) and minimum (MIN 411)). For a particular recipe step-sensor pair, such as Main Etch (401) and ESC Helium Flow (415), GUI 400 shows that the default value of 1.00 (421) continues to be the assigned importance factor for statistic AVG (405) for the Main Etch-ESC Helium Flow pair.

Returning to FIG. 2, if a statistic importance factor value is received (block 213), processing logic replaces the default value previously assigned with the received value as the assigned importance factor for the statistic at block 215. The statistic importance factor value can be received as a user input via a GUI. For example, in FIG. 4B, GUI 430 illustrates that for the Main Etch (431)-ESC Helium Flow (441) pair, the decreased value of 0.5 (451) was received and assigned to statistic standard deviation (STD 437). The decreased value can indicate a lesser degree of importance is placed on statistic standard deviation (STD 437) relative to other statistics for this recipe step-sensor pair. The replacement of the default value of 1.0 (not shown) with an increased value of 1.5 (453) for statistic maximum (MAX 439) can indicate a greater importance is placed on statistic maximum (MAX 439) relative to other statistics for the Main Etch-ESC Helium Flow pair.

Returning to FIG. 2, at block 217, an overall importance factor is calculated using the assigned importance factor for each variable. As described above, in one embodiment, an overall importance factor can be calculated using two variables, as illustrated by exemplary Equation 4:

IF=IF.sensor*IF.step Eq. 4

where IF.sensor is the assigned importance factor for a sensor and IF.step is the assigned importance factor for a recipe step. In another embodiment, an overall importance factor can be calculated using three variables, as illustrated by exemplary Equation 5:

IF=IF.sensor*IF.step*IF.statistic Eq. 5

where IF.statistic is the assigned importance factor value for a statistic (e.g., average, standard, minimum, maximum, median, area, slope, count range z, and range y, etc.) corresponding to a particular recipe step-sensor pair.

Using exemplary Equation 5 and the above Main Etch-ESC Helium Flow pair example in GUI 430, IF.sensor is the assigned importance factor 2.0 (443) for sensor ESC Helium Flow (441) and IF.step is the assigned importance factor 1.2 (433) for recipe step Main Etch (431). The corresponding importance factor, IF.statistic, for statistic average (AVG 435) for this pair is the pre-defined default value of 1.0 (445). In this example, the overall importance factor, IF, is illustrated at reference 447 in GUI 430 and calculated as:

IF=2.0*1.20*1.0=2.4

Returning to FIG. 2, at block 219, processing logic provides the overall importance factor. The overall importance factor, IF, is used to normalize variables for multivariate modeling results. The normalized variables can be used to calculate a model metric, for example, Qᵣₑₛ. The overall IF can be used to normalize variables using exemplary Equation 3 previously described:

$$z = IF * \frac{( x - \overline{x} )}{maximum ( {σ}_{x} , {σ}_{l )}} \qquad Eq . 3$$

where z is used in multivariate modeling results. z is the scaled value of variable x, x̅ is the mean value, σₓ is the standard deviation for variable x, σₜ is a threshold value determined by sensor resolution and IF is the presented overall importance factor.

The overall IF can be displayed in a GUI for a user to evaluate. GUI 430 of FIG. 4B is an example of displaying the calculated overall IF in gray shaded cells (e.g., 455). In other embodiments, a GUI can use other visual indicators (e.g., different patterns, different shading, different shapes, etc.) to display the overall importance factors. GUI 430 displays a calculated overall IF of 2.4 (447) for the pairing of Main Etch-ESC Helium Flow and corresponding statistic AVG 435. Using the same pairing, but where the corresponding statistic is standard deviation (STD 437), GUI 430 displays a calculated overall IF of 1.20 (449).

Returning to FIG. 2, at block 221, processing logic determines whether to provide different overall IF for a particular recipe step-sensor pairing. Using a GUI (e.g., GUIs 300, 360, 400 and 430), a user can change the values for the individual variables (e.g., sensor IF, recipe step IF and statistic IF) to generate a different overall IF until the overall IF is acceptable. A user can evaluate the overall IF based on the data displayed in a GUI to determine whether the overall IF is acceptable. At times, however, a user may not be able to determine whether the overall IF is acceptable based on the data presented in a GUI. In such cases, a user can wait for the final multivariate fault detection (MFD) results to determine if the overall IF is acceptable. A user can continue to modify the individual variables (e.g., sensor IF, recipe step IF, statistic IF) until the user determines an overall IF is acceptable. If processing logic determines a new overall IF is to be provided, processing logic returns to block 205 to receive a user input for a sensor IF. If processing logic determines that a new overall IF is not to be provided (block 221), method 200 completes.

FIG. 4C illustrates an exemplary GUI 460 to receive and display statistic specific importance factors in a sensor view, in accordance with one embodiment of the invention. In this example, GUI 460 manages importance factors associated with sensor ESC Helium Flow (461). As seen previously in GUI 300 of FIG. 3A, an importance factor value of 2.0 (324) was received and assigned to sensor ESC Helium Flow (314). In one embodiment, GUI 460 reflects the same information of GUI 300. For example, the assignment of 2.0 (463) as the importance factor for sensor ESC Helium Flow (461) reflects the assignment previously made in GUI 300.

GUI 460 can include a list of recipe steps (473) that correspond to a particular sensor. In this example, the recipe steps of Break Through 1, Break Through 2, Main Etch, and Dechuck correspond to sensor ESC Helium Flow (461). GUI 460 can display the recipe step importance factor (477) assigned to each recipe step. In one embodiment, the recipe step importance factor (477) corresponding to each recipe step reflects the previous assignments made using, for example, GUI 360 of FIG. 3B.

For each recipe step corresponding to sensor ESC Helium Flow (461), GUI 460 can manage statistics (e.g., average (AVG 465), standard deviation (STD 467), maximum (MAX 469), and minimum (MIN 471)). GUI 460 can include an interface to receive statistic importance factors for the individual statistics, as illustrated by cells 481 and 487. In other embodiments, a GUI can use other input interfaces to receive a statistic importance factor.

In this example, a default value of 1.0 (481) continues to be the assigned importance factor for the statistic average (AVG 465) corresponding to the ESC Helium Flow-Main Etch pair. GUI 460 also illustrates that for the ESC Helium Flow-Main Etch pair, the default importance factor of 1.0 (not shown) for statistic standard deviation (STD 467) was replaced by a decreased value of 0.5 (487). The replacement of the default value for the standard deviation (STD 467) with a decreased value of 0.5 (487) can indicate that a lesser degree of importance is placed on the statistic standard deviation (STD 467) for this sensor-recipe step pair. GUI 460 also illustrates, for the same pairing example, that the default importance factor of 1.0 (not shown) for statistic maximum (MAX 469) was replaced by an increased value of 1.5 (489). The replacement of the default value for the statistic maximum (MAX 469) with an increased value of 1.5 (489) can indicate that a greater degree of importance is placed on the statistic maximum (MAX 469) for this sensor-recipe step pair.

In GUI 460, resulting IFs are displayed in gray shaded cells (491). In other embodiments, a GUI can use other visual indicators (e.g., different patterns, different shading, different shapes, etc.) to present overall importance factors. Using the above ESC Helium Flow-Main Etch pair example, an overall IF for the ESC Helium Flow-Main Etch pair can be calculated using exemplary Equation 5:

IF=IF.sensor*IF.step*IF.statistic Eq. 5

where IF.sensor is assigned 2.0 (463) for sensor ESC Helium Flow (461), IF.step is assigned 1.2 (479) for recipe step Main Etch (475), and the corresponding IF.statistic, for statistic average (AVG 465) for this pair is the pre-defined default value of 1.0 (481). GUI 460 displays the calculated overall IF of 2.4 (483). Using the example of the same pair, where the statistic used is standard deviation (STD 467) for the pair, IF.statistic is assigned 0.5 (487) and the resulting overall IF presented is 1.20 (485).

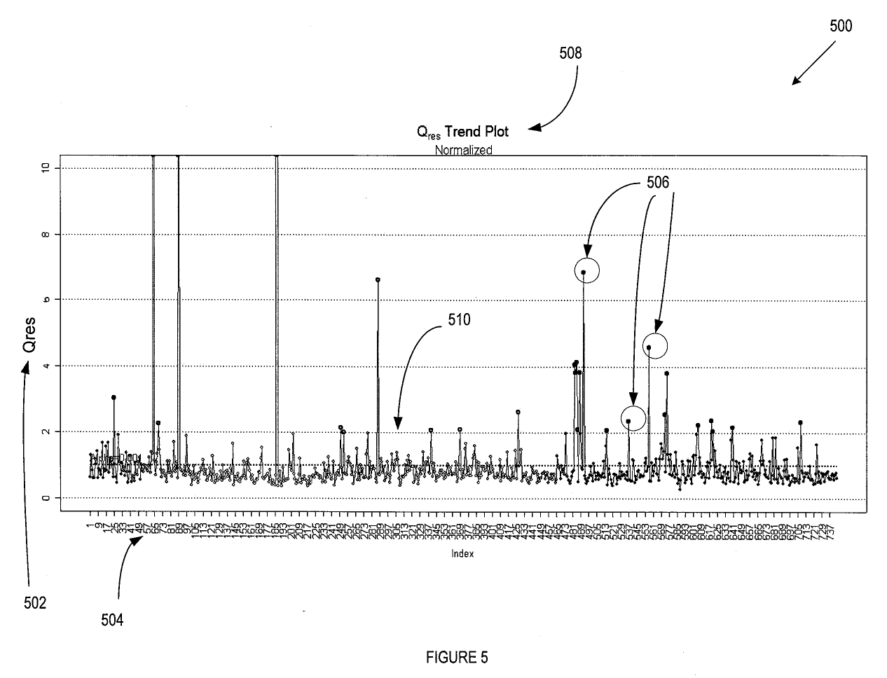

FIG. 5 illustrates an exemplary trend plot model (GUI 500) of a multivariate model metric Qᵣₑₛ 508 for multiple samples 504, which can be generated by GUI manager 135 of FIG. 1, according to one embodiment of the invention. In calculating model metric, Qᵣₑₛ 508, each of the variables can be normalized using an overall importance factor generated by the importance factor generator system 100 of FIG. 1. GUI 500 can allow a user to detect faults at a simple glance. If the model metric for one or more samples exceeds a predetermined threshold (referred to as a confidence limit or control limit), a fault can be detected for the corresponding sample. The x-axis represents an index of samples. Each sample 504 represents a wafer in a wafer manufacturing process. Qᵣₑₛ model metric values (502) on the y-axis are shown plotted against corresponding samples 504 on the x-axis. GUI 500 illustrates that the Qᵣₑₛ confidence threshold is a value of 2.0 represented by line 510. Accordingly, any sample or wafer with a Qᵣₑₛ value exceeding the predetermined confidence threshold infers there is at least a variable causing a fault. For example, points 506 are above the hypothetically pre-determined threshold. As such, a fault can be detected for the sample corresponding to each point 506.

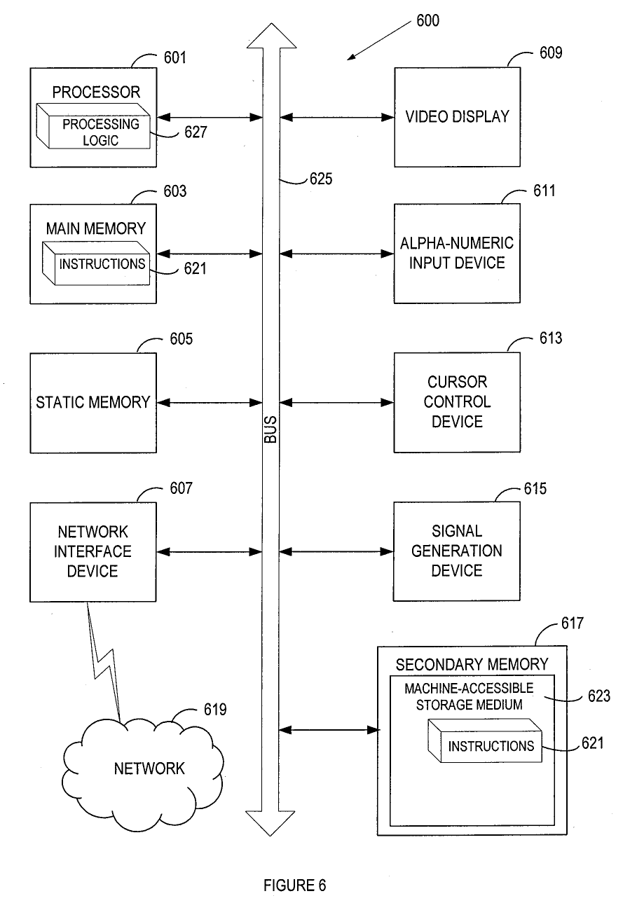

FIG. 6 illustrates a diagrammatic representation of a machine in the exemplary form of a computer system 600 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 600 includes a processing device (processor) 601, a main memory 603 (e.g., read-only memory (ROM), flash memory, dynamic random access memory (DRAM) such as synchronous DRAM (SDRAM) or Rambus DRAM (RDRAM), etc.), a static memory 605 (e.g., flash memory, static random access memory (SRAM), etc.), and a data storage device 617, which communicate with each other via a bus 625.

Processor 601 represents one or more general-purpose processing devices such as a microprocessor, central processing unit, or the like. More particularly, the processor 601 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 601 may also be one or more special-purpose processing devices such as an application specific integrated circuit (ASIC), a field programmable gate array (FPGA), a digital signal processor (DSP), network processor, or the like. The processor 601 is configured to execute the processing logic 627 for performing the operations and steps discussed herein.

The computer system 600 may further include a network interface device 607. The computer system 600 also may include a video display unit 609 (e.g., a liquid crystal display (LCD) or a cathode ray tube (CRT)), an alphanumeric input device 611 (e.g., a keyboard), a cursor control device 914 (e.g., a mouse), and a signal generation device 615 (e.g., a speaker).

The data storage device 617 may include a machine-accessible storage medium 623 on which is stored one or more sets of instructions 621 (e.g., software) embodying any one or more of the methodologies or functions described herein. The software 621 may also reside, completely or at least partially, within the main memory 603 and/or within the processor 601 during execution thereof by the computer system 600, the main memory 603 and the processor 601 also constituting machine-accessible storage media. The software 621 may further be transmitted or received over a network 619 via the network interface device 607.

The machine-accessible storage medium 623 may also be used to store data structure sets that define user identifying states and user preferences that define user profiles. Data structure sets and user profiles may also be stored in other sections of computer system 600, such as static memory 605.

While the machine-accessible storage medium 623 is shown in an exemplary embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instructions for execution by the machine and that cause the machine to perform any one or more of the methodologies of the present invention. The term “machine-accessible storage medium” shall accordingly be taken to include, but not be limited to, solid-state memories, optical and magnetic media, and carrier wave signals.

It is to be understood that the above description is intended to be illustrative, and not restrictive. Many other embodiments will be apparent to those of skill in the art upon reading and understanding the above description.

What is claimed is:

1. A computer-implemented method comprising:
assigning a sensor importance factor to one of a plurality of sensors, wherein the sensor importance factor indicates an importance of the one sensor relative to the plurality of sensors;
assigning a recipe step importance factor to one of a plurality of recipe steps, the one recipe step being associated with the one sensor, wherein the recipe step importance factor indicates an importance of the one recipe step relative to the plurality of recipe steps;
calculating an overall importance factor using the importance factor assigned to the one sensor and the importance factor assigned to the one recipe step associated with the one sensor; and
providing the overall importance factor for normalizing variables in generating multivariate model results.

2. The computer-implemented method of claim 1, wherein providing the overall importance factor includes displaying the overall importance factor in a graphical user interface (GUI).

3. The computer-implemented method of claim 1, wherein calculating the overall importance factor comprises calculating the overall importance factor as:
IF=IF.sensor*IF.step
where, IF.sensor is the sensor importance factor assigned to the one sensor, IF.step is the recipe step importance factor assigned to the one recipe step, and IF is the overall importance factor.

4. The computer-implemented method of claim 1, further comprising:
assigning a statistic importance factor to one of a plurality of statistics associated with the one sensor and the one recipe step, wherein the statistic importance factor indicates an importance of the one statistic relative to the plurality of statistics for the associated one sensor and the associated one recipe step; and
calculating an overall importance factor using the importance factor assigned to the one sensor, the importance factor assigned to the one recipe step, and the importance factor assigned to the one statistic.

5. The computer-implemented method of claim 4, wherein calculating the overall importance factor comprises calculating the overall importance factor as:
IF=IF.sensor*IF.step*IF.statistic
where, IF.sensor is the sensor importance factor assigned to the one sensor, IF.step is the recipe step importance factor assigned to the one recipe step, IF.statistic is the statistic importance factor assigned to the one statistic, and IF is the overall importance factor.

6. The computer-implemented method of claim 4, wherein assigning a statistic importance factor to one of a plurality of statistics comprises:
providing a default importance factor as an assigned importance factor for each of the plurality of statistics;
determining whether a statistic importance factor for one of the plurality of statistics is received; and
replacing the default importance factor for the one statistic with the received statistic importance factor as the assigned importance factor for the one statistic if a statistic importance factor for one of the plurality of statistics is received.

7. The computer-implemented method of claim 6, wherein a statistic importance factor for one of the plurality of statistics is received as a user input via a GUI.

8. The computer-implemented method of claim 1, wherein assigning a sensor importance factor to one of a plurality of sensors comprises:
providing a default importance factor as an assigned importance factor for each of the plurality of sensors;
determining whether a sensor importance factor for one of the plurality of sensors is received; and
replacing the default importance factor for the one sensor with the received sensor importance factor as the assigned importance factor for the one sensor if a sensor importance factor for one of the plurality of sensors is received.

9. The computer-implemented method of claim 8, wherein a sensor importance factor for one of the plurality of sensors is received as a user input via a graphical user interface (GUI).

10. The computer-implemented method of claim 1, wherein assigning a recipe step importance factor to one of a plurality of recipe steps comprises:
providing a default importance factor as an assigned importance factor for each of the plurality of recipe steps;
determining whether a recipe step importance factor for one of the plurality of recipe steps is received; and
replacing the default importance factor for the one recipe step with the received recipe step importance factor as the assigned importance factor for the one recipe step if a recipe step importance factor for one of the plurality of recipe steps is received.

11. The computer-implemented method of claim 10, wherein a recipe step importance factor for one of the plurality of recipe steps is received as a user input via a GUI.

12. A computer system comprising:
a memory to store an importance factor assigned to each of a plurality of sensors and each of a plurality of recipe steps;
a processor coupled to a memory through a bus; and
instructions executed from the memory by the processor to cause the processor to generate an overall importance factor for an association of one of the plurality of sensors with one of the plurality of recipe steps using the importance factor assigned to the one sensor and the importance factor assigned to the one recipe step associated with the one sensor.

13. The computer system of claim 12, wherein:
the memory is further to store an importance factor assigned to each of a plurality of statistics; and
the instructions executed from the memory by the processor to cause the processor further to generate an overall importance factor for an association of the one sensor with the one recipe step with one of the plurality of statistics using the importance factor assigned to the one sensor, the importance factor assigned to the one recipe step, and the importance factor assigned to the one statistic.

14. The computer system of claim 13, wherein the processor is further:
to manage the importance factor for each of the plurality of sensors, each of the plurality of recipe steps, and each of the plurality of statistics.

15. The computer system of claim 12, wherein the processor is further:
to generate a plurality of graphical user interfaces (GUI) for displaying the overall importance factor, the importance factor for each of the plurality of sensors and the importance factor for each of the plurality of recipe steps.

16. The computer system of claim 15, wherein the plurality of GUIs is further for managing the importance factor for each of the plurality of statistics and overall importance factors.

17. The computer system of claim 16, wherein the plurality of GUIs manages the importance factor for each of the plurality of statistics, and overall importance factors in a sensor view.

18. The computer system of claim 16, wherein the plurality of GUIs manages the importance factor for each of the plurality of statistics, and overall importance factors in a recipe step view.

19. A machine-accessible storage medium that provides instructions that, if executed by a machine, will cause the machine to perform operations, comprising:
assigning a sensor importance factor to one of a plurality of sensors, wherein the sensor importance factor indicates an importance of the one sensor relative to the plurality of sensors;
assigning a recipe step importance factor to one of a plurality of recipe steps, the one recipe step being associated with the one sensor, wherein the recipe step importance factor indicates an importance of the one recipe step relative to the plurality of recipe steps;
calculating an overall importance factor using the importance factor assigned to the one sensor and the importance factor assigned to the one recipe step associated with the one sensor; and
providing the overall importance factor for normalizing variables in generating multivariate model results.

20. The machine-accessible storage medium of claim 19, wherein providing the overall importance factor includes displaying the overall importance factor in a GUI.

21. The machine-accessible storage medium of claim 19, further comprising:
assigning a statistic importance factor to one of a plurality of statistics associated with the one sensor and the one recipe step, wherein the statistic importance factor indicates an importance of the one statistic relative to the plurality of statistics for the associated one sensor and the associated one recipe step; and
calculating an overall importance factor using the importance factor assigned to the one sensor, the importance factor assigned to the one recipe step, and the importance factor assigned to the one statistic.
